(19) United States
(12) Patent Application Publication
(10) Pub. No.: US 2026/0331936 A1
(43) Pub. Date: Oct. 22, 2026

(54) Dynamic Multi-Phase Defined Pattern Charging (DDPC) System and Method for Battery Formation, Optimization, and Ultra-Fast Applications

(71) Applicant: Ibrahim Karakoc, Bornova/ Izmir (TR)

(72) Inventor: Ibrahim Karakoc, Bornova/ Izmir (TR)

(21) Appl. No.: 19/298,223

(22) Filed: Aug. 13, 2025

(51) Int. Cl. H02J 7/00; H01M 10/44

(52) U.S. Cl. CPC H02J 7/84; H01M 10/446; H02J 7/94; H02J 7/96; H02J 2207/40

(57) ABSTRACT

A dynamic multi-phase defined pattern charging (DDPC) system and method for optimizing the charging of rechargeable battery cells and battery systems. The invention applies a predefined, repeatable charge pattern such as square, ramped square, sinusoidal, tangential, sawtooth, or phase-shifted dual-source forms to each charging phase, while dynamically adjusting offset, amplitude, and duty cycle parameters based on real-time feedback from voltage, current, temperature, and impedance measurements. Unlike conventional adaptive charging, which continuously varies current and treats the resulting profile as a shifting waveform, the DDPC approach uses fixed-shape patterns and adjusts only offset, amplitude, and duty cycle. This preserves pattern stability, improves repeatability, and enhances electrochemical predictability. The system supports single-source, dual-source, and multi-source configurations, and can switch patterns during charging to enhance SEI formation, reduce thermal stress, or accelerate completion. Applicable to manufacturing formation lines, in-field optimization, and ultra-fast charging scenarios.

### CROSS-REFERENCE TO RELATED APPLICATIONS.

This application claims the benefit of U.S. Provisional Patent Application No. 63/849,508, filed Jul. 23, 2025, entitled “System and Method for Pre-Activation Conditioning of Electrochemical Battery Cells, Including Advanced and Solid-State Variants”, the entire disclosure of which is incorporated herein by reference.

This application further builds upon the concepts disclosed in the provisional filing by introducing a Dynamic Multi-Phase Defined Pattern Charging (DDPC) System, capable of operating in single-source, dual-source, or multi-source configurations, and optimized for battery formation, lifecycle re-balancing, and high-power ultra-fast charging.

### FIELD OF THE INVENTION.

The present invention relates to battery charging systems and methods, and more particularly to a Dynamic Multi-Phase Defined Pattern Charging (DDPC) System capable of operating in single-source, dual-source, or multi-source configurations. The invention provides a structured, repeatable charging pattern methodology for optimized cell formation, operational re-balancing, and high-power ultra-fast charging.

Unlike conventional adaptive charging systems—which continuously alter current in response to feedback without following a fixed, pre-designed pattern—the invention applies predefined, repeatable current patterns (including square, ramped square, sinusoidal, tangential, sawtooth, and phase-shifted dual-source forms) and dynamically adjusts only offset, amplitude, and duty cycle parameters during charging, based on live cell data. Optionally, the system may switch to another predefined pattern during charging if feedback indicates that such a change would deliver improved SEI stability, reduced thermal stress, or faster completion time.

This approach fundamentally differs from state-of-the-art “adaptive” systems, such as those employed in certain existing commercial technologies, which treat the entire charge profile as a continuously shifting waveform. In contrast, the present invention maintains a fixed and pre-engineered pattern within each phase, introducing dynamic parameter adjustments only within the boundaries of that pattern. This provides higher repeatability, predictable electrochemical behaviour, improved diagnostic traceability, and a clear separation from systems that modify the waveform shape itself in real time.

The invention is applicable across multiple lifecycle phases of a battery: from manufacturing formation lines (Phase 1), through OEM and in-field optimization (Phase 2), to performance extension and ultra-fast charging scenarios (Phase 3). It can be implemented in gigafactories, OEM service infrastructures, mega-charging stations, and specialized applications such as grid storage, aerospace, marine energy systems, and high-reliability IoT devices.

### BACKGROUND OF THE INVENTION

Rechargeable electrochemical batteries, particularly lithium-ion and emerging solid-state chemistries, require precise charge control to achieve optimal performance, safety, and longevity. The charging methodology used during a cell's initial formation cycle, throughout its operational life, and in high-demand scenarios significantly influences internal electrochemical structures such as the solid electrolyte interphase (SEI), lithium plating behaviour, internal resistance growth, and thermal stability.

Traditional charging methods, such as constant-current/constant-voltage (CC/CV) profiles, apply a uniform charge pattern to all cells in a pack regardless of their individual characteristics. While simple and widely implemented, these approaches do not account for variations in cell impedance, temperature gradients, or state-of-health differences. Over time, such uniform treatment leads to internal imbalance, accelerated degradation, and reduced usable capacity.

Certain “adaptive” charging systems have been developed that adjust current in real time based on feedback from the cell or pack. However, these systems typically treat the entire charging profile as a continuously shifting waveform, which can make results less predictable, reduce diagnostic repeatability, and complicate correlation between laboratory testing and field operation. Furthermore, such methods often require rapid high-bandwidth control loops that may inadvertently introduce oscillations or instability into the charging process.

The present invention introduces a Dynamic Multi-Phase Defined Pattern Charging (DDPC) system (110), in which each phase of charging uses a predefined, repeatable pattern—such as square, ramped square, sinusoidal, tangential, sawtooth, or phase-shifted dual-source forms (150)—selected for the specific electrochemical and operational goals of that phase. Instead of altering the pattern shape in real time, the system dynamically adjusts offset, amplitude, and duty cycle parameters within the selected pattern based on live feedback from the Feedback Interface (140). This hybrid methodology delivers the adaptability needed to optimize performance, while preserving the repeatability and controllability of a fixed pattern structure.

The DDPC method (110) is applicable to multiple battery lifecycle stages: 1—Manufacturing formation, where the method optimizes initial SEI formation, minimizes irreversible capacity loss, and reduces total formation cycle time; 2—OEM and in-field optimization, where the method restores cell balance, compensates for capacity degradation, and maintains consistent module matching; and 3—Performance extension and ultra-fast charging, where the method enables high-power energy delivery while maintaining thermal stability and cycle life.

It is compatible with single-source Power Source (100), dual-source (150), and multi-source charging hardware, and can be deployed in applications ranging from gigafactory production lines to grid storage, aerospace, marine, and high-reliability IoT systems.

Furthermore, the architecture of the DDPC system (110) allows seamless deployment in both high-volume manufacturing environments and distributed field-charging scenarios. In gigafactory applications, DDPC (110) can be integrated directly into formation lines and end-of-line testing stations without requiring significant redesign of existing infrastructure. In field environments, the system can be embedded into OEM service tools, public or private charging stations, or retrofit kits for existing Battery Systems (130) and stationary storage systems. This dual-environment compatibility maximizes commercial applicability, accelerates adoption, and ensures that the technology can deliver benefits across the entire battery value chain.

### SUMMARY OF THE INVENTION

The present invention provides a ynamic Multi-Phase Defined Pattern Charging (DDPC) system (110) and method for controlling the charge delivery to electrochemical battery cells (130) across multiple liDfecycle phases. The DDPC approach (110) maintains a predefined, repeatable current pattern within each charging phase—such as square, ramped square, sinusoidal, tangential, sawtooth, or phase-shifted dual-source forms (150)—while dynamically adjusting offset, amplitude, and duty cycle parameters in real time based on live feedback from the Feedback Interface (140).

Unlike conventional adaptive charging systems that treat the charge profile as a continuously shifting waveform, DDPC (110) preserves the shape and timing of the selected pattern for the duration of a phase, enabling predictable electrochemical behavior, reproducible results, and precise diagnostics. Pattern changes occur only when operational feedback from the Feedback Interface (140) indicates a clear benefit, such as improved SEI stability, reduced thermal stress, or shorter completion times.

The invention is structured into three primary operational phases: 1-Phase 1—Manufacturing Formation: Application during manufacturing to optimize initial SEI formation, minimize irreversible capacity loss, and accelerate formation cycle times using the Power Source (100) and DDPC (110) logic. 2-Phase 2—OEM and In-Field Optimization: In-field or OEM service application to restore cell balance, mitigate aging effects, and maintain peak performance through pattern-based control (110). 3-Phase 3—Performance Extension & Ultra-Fast Charging: High-power charging scenarios optimized for thermal stability, cycle life extension, and rapid energy delivery, optionally using dual-source (150) or multi-source configurations.

The DDPC architecture (110) supports single-source (100), dual-source (150), and multi-source charging configurations. In manufacturing environments, the system integrates into gigafactory formation lines, module assembly stations, and end-of-line testing without requiring significant redesign. In the field, DDPC (110) can be embedded into OEM diagnostic tools, public and private charging infrastructure, or retrofit modules for existing battery systems (130), including electric vehicles, grid storage units, aerospace platforms, and marine energy systems.

Through this combination of fixed-pattern control and dynamic parameter tuning, the DDPC method (110) delivers improved electrochemical precision, operational flexibility, and commercial scalability—enabling a single charging methodology to serve both high-volume production and distributed field applications.

### BRIEF DESCRIPTION OF THE DRAWINGS

FIG. 1—Multi-Phase Charging Flow Overview (110, 100, 150, 130, 140) This figure illustrates the three-phase DDPC system (110) strategy applied throughout the lifecycle of a battery cell (130), from manufacturing to ultra-fast field charging. Each step is represented by a labelled block, connected left to right by arrows. The Power Source (100) and optional dual-source configuration (150) are indicated where relevant, with control and monitoring via the Feedback Interface (140).

FIG. 2—Single-Source DDPC Architecture (110, 100, 140, 130) Depicts the internal control structure of the DDPC system (110) operating with a single Power Source (100). Shows the predefined pattern generation module, feedback processing from the Feedback Interface (140), and current delivery path to the battery cell (130).

FIG. 3—Dual-Source DDPC Architecture (110, 100, 150, 140, 130) Shows a dual-source configuration (150) in the DDPC system (110), where two independent Power Sources (100) deliver complementary patterns to the same battery cell (130). Includes isolation components, pattern synchronization logic, and feedback-driven parameter adjustment via the Feedback Interface (140).

FIG. 4—Pattern Library and Control Flow (110) Illustrates the predefined pattern library (square, ramped square, sinusoidal, tangential, sawtooth, phase-shifted dual-source) and the control flow that governs selection, application, and parameter adjustment in the DDPC system (110).

FIG. 5—Parameter Adjustment Mechanism (110, 140) Shows how the Feedback Interface (140) measures live cell data (voltage, current, temperature, impedance) and how the DDPC control logic (110) adjusts offset, amplitude, and duty cycle without altering the pattern shape.

FIG. 6—Gigafactory Integration Example (110, 100, 150) Demonstrates deployment of the DDPC system (110) in a manufacturing formation line using both single-source (100) and dual-source (150) configurations. Highlights minimal hardware changes required for integration.

FIG. 7—In-Field Optimization Setup (110, 100) Depicts an OEM or service environment where the DDPC system (110) is embedded in a portable or stationary charger, connected to the Power Source (100), enabling real-time battery optimization.

FIG. 8—Ultra-Fast Charging Configuration (110, 150, 100) Illustrates an ultra-fast charging station using dual-source (150) delivery with coordinated predefined patterns to minimize thermal stress while delivering high charging power.

FIG. 9—Feedback Data Loop (110, 140) Details the closed-loop control process between the Feedback Interface (140) and the DDPC controller (110), showing measurement, analysis, and parameter tuning cycles.

FIG. 10—DDPC System Applied to Various Applications (110, 100, 150, 130) Shows how the DDPC system (110) can be adapted for electric vehicles, grid storage, aerospace, marine, and IoT applications, using single-source (100) or dual-source (150) configurations to charge different types of battery systems (130).

### DETAILED DESCRIPTION OF THE INVENTION

The present invention relates to a Dynamic Multi-Phase Defined Pattern Charging (DDPC) system and method for controlling the charging of rechargeable electrochemical battery cells and battery systems, including but not limited to lithium-ion, lithium-polymer, and solid-state chemistries. The system is designed to deliver electrical energy from one or more Power Sources (100) to a target Battery Cell or System (130) using predefined, repeatable charge patterns stored in a pattern library.

Unlike conventional adaptive charging systems, which continuously vary current in response to feedback and consider the resulting time-current curve as a “waveform,” the DDPC system applies a predefined pattern of fixed shape—such as square, ramped square, sinusoidal, tangential, sawtooth, or phase-shifted dual-source profiles—and maintains this shape throughout a given charging phase. Adaptability is achieved by dynamically adjusting offset, amplitude, and duty cycle parameters based on real-time feedback without altering the core pattern geometry. This approach combines the repeatability and predictability of fixed patterns with the flexibility of parameter tuning.

The DDPC system operates across multiple lifecycle phases of a battery: 1—Manufacturing Formation Phase—Initial conditioning to establish a stable solid electrolyte interphase (SEI), optimize active material structure, and minimize early capacity loss. 2—OEM and In-Field Optimization Phase—Corrective and maintenance charging to rebalance modules, compensate for degradation, and restore capacity uniformity across packs. 3—Performance Extension/Ultra-Fast Charging Phase—High-power operation designed to reduce thermal stress and maintain electrochemical stability during rapid charging events.

The system architecture is compatible with single-source, dual-source, or multi-source configurations. In the dual-source configuration, two independent Power Sources (100)—referred to as Power Source A (160) and Power Source B (170)—deliver coordinated patterns that can be synchronized, phase-shifted, or amplitude-modulated to achieve desired electrochemical effects.

A Feedback Interface (140) continuously monitors key parameters, including voltage, current, temperature, and impedance, and provides this data to the DDPC control logic. Based on the monitored data, the control system may adjust the pattern parameters in real time or optionally switch to another predefined pattern during charging if such a change is predicted to improve SEI stability, reduce thermal stress, or accelerate charging completion.

The DDPC methodology can be implemented in:

Gigafactory environments, integrated directly into formation lines and end-of-line testing stations.

OEM service infrastructure, embedded in portable diagnostic chargers or stationary maintenance equipment.

Public or private charging stations, including ultra-fast “mega charging” systems.

Specialized applications, such as grid storage systems, aerospace power platforms, marine energy storage, and high-reliability IoT devices.

By combining a structured, repeatable pattern approach with adaptive parameter control, the DDPC system enables consistent, predictable, and optimized charging across a wide range of operating conditions and application domains.

### DETAILED DESCRIPTION OF THE DRAWINGS

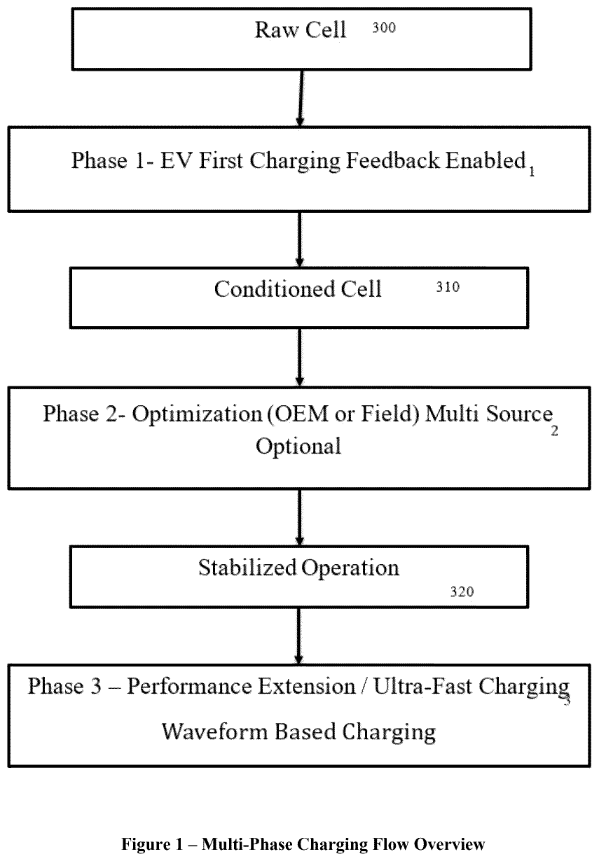

Referring now to FIG. 1, the present invention comprises a Dynamic Multi-Phase Defined Pattern Charging (DDPC) system (110) configured to control the delivery of electrical energy from one or more Power Sources (100) to one or more Battery Cells or Systems (130). The DDPC system (110) is capable of operating in single-source mode or dual-source configuration (150), with both configurations governed by a predefined, repeatable charge pattern stored in a pattern library. The system further incorporates a Feedback Interface (140), which continuously monitors key operational parameters of the Battery Cell (130) such as voltage, current, temperature, and impedance, and provides real-time data to the DDPC control logic.

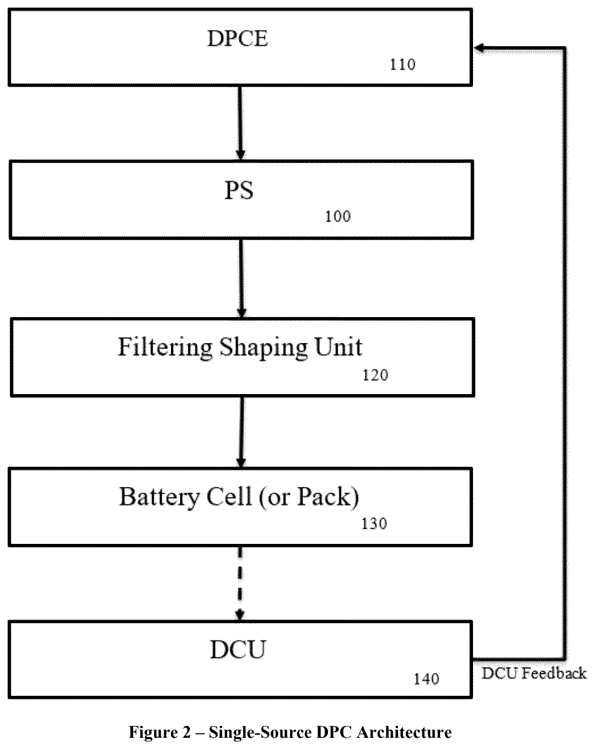

As shown in FIG. 2, in a single-source configuration, the Power Source (100) is connected to the Battery Cell (130) through the DDPC control module (110). The control module selects a pattern from the internal library (square, ramped square, sinusoidal, tangential, sawtooth) based on the operational phase—Phase 1: Manufacturing Formation, Phase 2: OEM and In-Field Optimization, or Phase 3: Performance Extension & Ultra-Fast Charging—and maintains this pattern shape throughout the charging phase. Dynamic adjustments to offset, amplitude, and duty cycle are made based on data received from the Feedback Interface (140), without altering the fundamental pattern shape. This ensures electrochemical repeatability, minimizes SEI instability, and improves diagnostic correlation between laboratory testing and field operation.

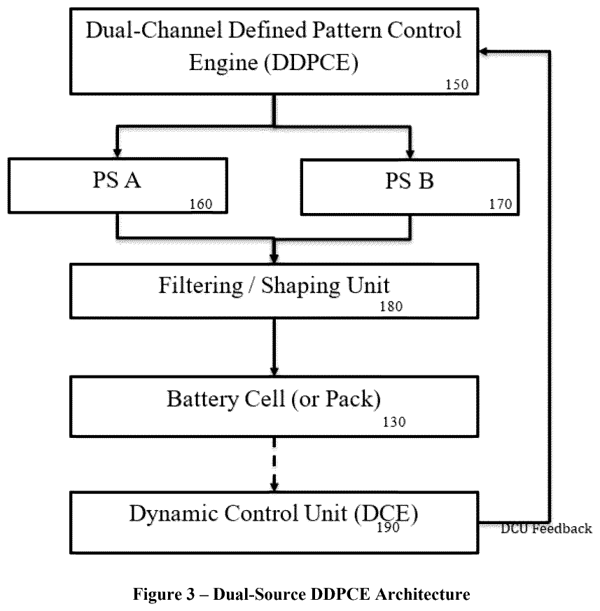

In the dual-source configuration (150), as illustrated in FIG. 3, two independent Power Sources (100) are connected to the Battery Cell (130) via isolated delivery paths, each governed by the DDPC system (110). Each source can deliver a distinct predefined pattern, and the patterns can be phase-shifted relative to one another to achieve specific electrochemical effects, such as enhanced SEI formation, thermal load balancing, or reduced lithium plating. Isolation circuits ensure that current from one source does not back-feed into the other. Synchronization logic within the DDPC controller (110) maintains precise timing between the two delivery channels, preventing destructive interference and ensuring constructive overlap where desired.

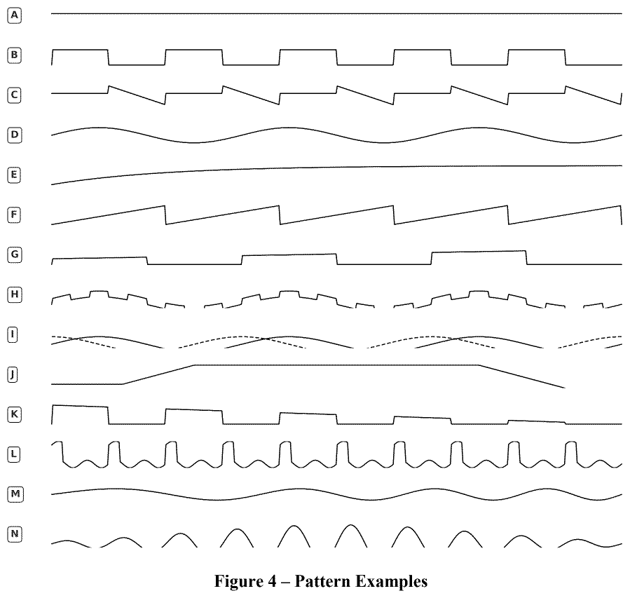

As shown in FIG. 4, the pattern library within the DDPC control module (110) contains multiple selectable waveforms, including square, ramped square, sinusoidal, tangential, sawtooth, and phase-shifted dual-source profiles. These patterns are stored in digital form and may be implemented in hardware, firmware, or software. The selection of a pattern is determined by the operational phase and user-defined optimization targets. Once a pattern is selected for a given phase, its shape remains constant, with only offset, amplitude, and duty cycle being dynamically adjusted based on Feedback Interface (140) measurements. This approach allows the system to adapt to real-time battery conditions while maintaining repeatable and predictable electrochemical outcomes.

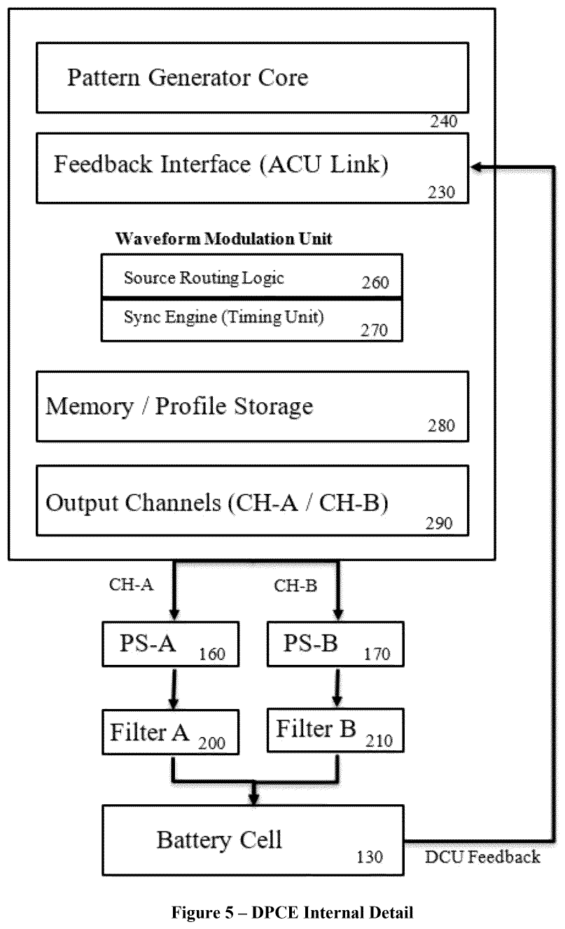

As illustrated in FIG. 5, the Feedback Interface (140) continuously measures voltage, current, temperature, and impedance of the Battery Cell (130) during charging. This data is processed by the DDPC control logic (110) to calculate optimal adjustments to the active pattern parameters. By controlling these parameters without altering the base pattern, the system ensures that each charge cycle produces consistent electrochemical effects, enabling direct comparison between laboratory validation and in-field performance.

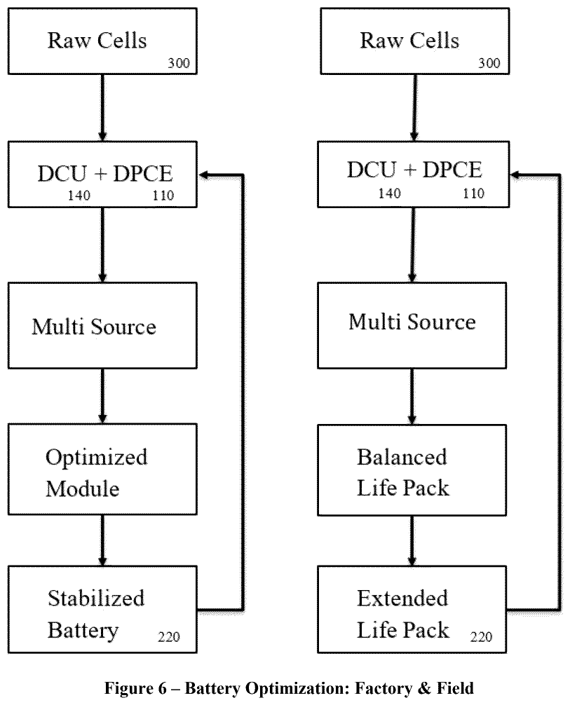

As shown in FIG. 6, the DDPC system (110) can be integrated into high-volume manufacturing environments, such as gigafactory formation lines, without requiring significant redesign of existing infrastructure. In a typical deployment, single-source Power Sources (100) are already installed at each formation station; the DDPC controller (110) is added in-line between the existing power electronics and the Battery Cell (130). For applications requiring more advanced conditioning, the system can be upgraded to a dual-source configuration (150) by adding a secondary isolated Power Source (100) and synchronization logic. This allows both Phase 1 conditioning and advanced balancing patterns to be performed in the same hardware footprint. The integration process leverages existing monitoring hardware, with the Feedback Interface (140) either replacing or augmenting factory measurement systems.

In addition to formation, the DDPC system (110) can be deployed in end-of-line testing environments. Here, the repeatable pattern methodology allows OEMs to correlate test results across different production runs and facilities. Since the patterns are fixed and parameter-controlled, cell performance data obtained during EOL testing can be directly compared to field performance years later, enabling long-term product validation and warranty analysis.

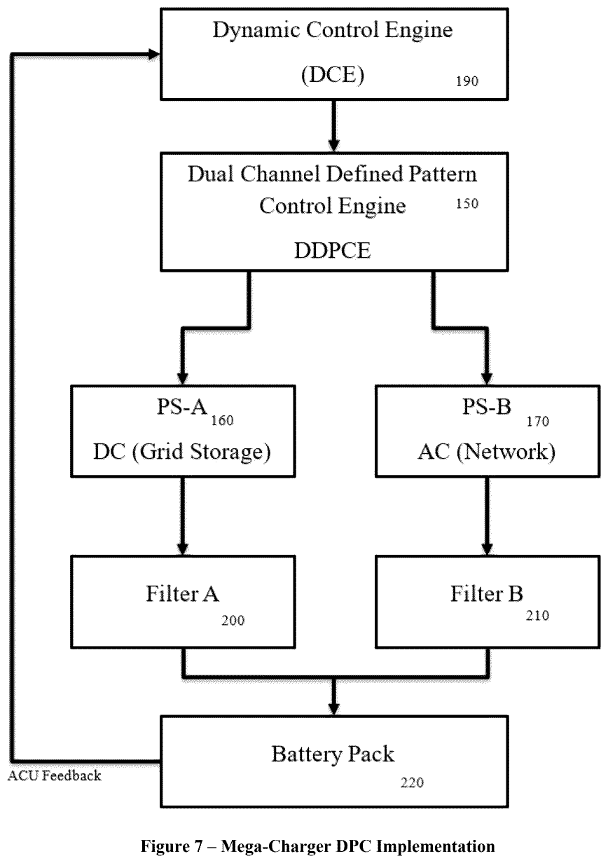

As illustrated in FIG. 7, the DDPC system (110) is equally suited for in-field use. In OEM and service environments, the system can be embedded into portable diagnostic chargers or stationary service equipment. When connected to a Battery System (130) in a vehicle or stationary application, the DDPC controller (110) can run a targeted optimization cycle using either a single-source (100) or dual-source (150) configuration. Feedback from the Feedback Interface (140) enables real-time degradation compensation, module rebalancing, and restoration of capacity uniformity across the pack.

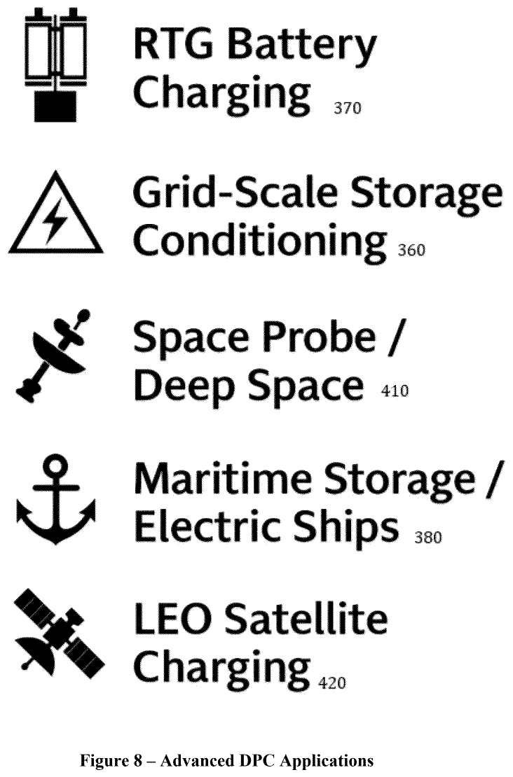

In FIG. 8, an ultra-fast charging station implementation is shown, where a dual-source configuration (150) delivers two coordinated patterns to the Battery System (130). One channel may operate at a higher amplitude to rapidly increase state-of-charge, while the second channel operates at a lower amplitude but higher frequency to stabilize ion distribution and control thermal rise. This division of roles between channels enables faster charging without the high thermal stress typically associated with ultra-fast charging.

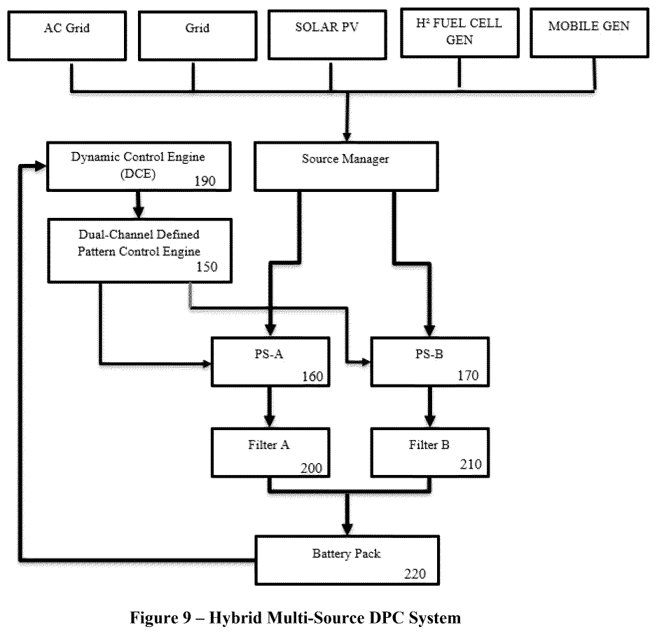

As detailed in FIG. 9, the closed-loop feedback system is critical to DDPC operation. The Feedback Interface (140) acquires high-resolution operational data at defined intervals and transmits it to the DDPC controller (110). The controller processes this data against predefined thresholds for SEI stability, internal resistance growth, and temperature rise. If a threshold is approached, the system adjusts offset, amplitude, or duty cycle within the active pattern to maintain stability while preserving charge time objectives.

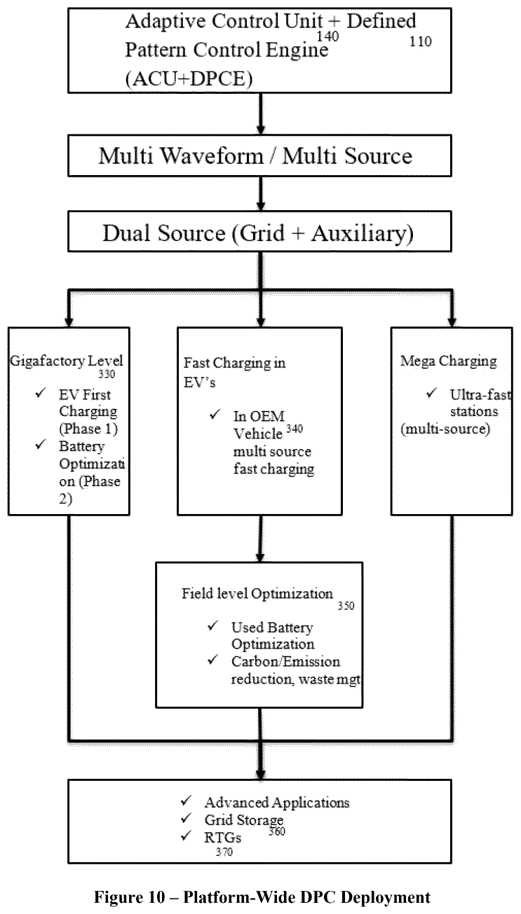

Finally, FIG. 10 illustrates the broad application scope of the DDPC system (110). Beyond gigafactory and OEM service use, the system can be implemented in grid storage systems, aerospace power platforms, marine energy storage, and high-reliability IoT devices. In each case, the use of predefined patterns with parameter tuning provides a balance between adaptability and repeatability, ensuring both performance optimization and long-term reliability.

### REFERENCE NUMERALS LIST

1—Phase 1: Manufacturing Formation.
2—Phase 2: OEM and In-Field Optimization.
3—Phase 3: Performance Extension & Ultra-Fast Charging.
4—Pattern Type 1 (Square).
5—Pattern Type 2 (Ramped Square).
6—Pattern Type 3 (Sinusoidal).
7—Pattern Type 4 (Tangential).
8—Pattern Type 5 (Sawtooth).
9—Pattern Type 6 (Phase-Shifted Dual-Source).
10—General Charging Flow Indicator.
100—Power Source (PS).
110—Defined Pattern Control Engine (DPCE).
120—Filtering/Shaping Unit.
130—Battery Cell.
140—Dynamic Control Unit (DCU).
150—Dual-Channel Defined Pattern Control Engine (DDPCE).
160—Power Source A (PSA).
170—Power Source B (PSB).
180—Merge/Filter Unit.
190—Adaptive Control Engine (ACE).
200—Filter A.
210—Filter B.
220—Battery Pack.
230—Feedback Interface (DCU Link).
240—Pattern Generator Core.
250—Pattern Modulation Unit.
260—Source Routing Logic.
270—Sync Engine (Timing Unit).
280—Memory/Profile Storage.
290—Output Channels (CH-A/CH-B).
300—Raw Cell.
310—Conditioned Cell.
320—Stabilized Operation.
330—GigaFactory.
340—OEM Vehicle.
350—Field-Level Battery Optimization.
360—Grid Storage.
370—RTG-Based Space Systems.
380—Marine Energy Systems.
390—Implantable Medical Devices.
400—Critical Industrial IoT.
410—Additional Industrial IoT Application.
420—Specialized Aerospace or Defense Application.

1. A system for controlling delivery of electrical energy from at least one power source (100) to at least one electroactive device (130), the system comprising:
a pattern generation module (240) configured to apply a pre-engineered, fixed-geometry current excitation pattern—referred to herein as Generated Pattern Current (GPC)—to the electroactive device (130), wherein said pattern is generated prior to operation through electrochemical engineering analysis of the target device chemistry or process, and is selected from a pre-engineered pattern set in which each pattern has a fixed geometric structure designed independently of operational feedback;
a parameter adjustment engine (190) configured to dynamically adjust one or more scalar delivery parameters of the selected pattern, including offset, amplitude, and duty cycle, during operation based on real-time data received from a feedback interface (140) that monitors at least voltage, current, temperature, and impedance of the electroactive device (130), without altering the fixed geometric structure of the pattern;
a control engine (110, 150) configured to maintain the fixed geometric structure of the selected pattern throughout a given operational phase while applying said scalar parameter adjustments, and optionally switch to another pre-engineered pattern from the pre-engineered pattern set if the feedback interface (140) indicates that such a change will improve process stability, reduce thermal stress, or optimize process completion, wherein said switching constitutes a transition between two independently engineered fixed-geometry patterns, and not a modification of the pattern geometry in response to feedback;
wherein the system is operable in single-source or multi-source configurations;
and wherein the system is applicable to any electroactive system or process whose outcome depends on the temporal structure of electrical excitation, including but not limited to electrochemical energy storage systems including lithium-ion, solid-state, sodium-ion, lithium-sulfur, multivalent-ion, zinc-based, redox-flow, metal-air, and equivalent battery chemistries; electrochemical energy conversion devices including fuel cells and photovoltaic systems; electrochemical capacitors, supercapacitors, and hybrid capacitors; industrial electrochemical processes including water electrolysis, hydrogen production, electroplating, electrochemical dissolution, anodizing, electropolishing, electroforming, and electrochemical synthesis; electrochemical material processing including graphene and two-dimensional material exfoliation and deposition; semiconductor and electronic device conditioning including electrical annealing, dopant activation, memristive element programming, and plasma-enhanced chemical vapor deposition conditioning; electrochemical water and wastewater treatment including electrocoagulation, electrooxidation, electrochlorination, and electrodialysis; textile electrochemical processing including dyeing, bleaching, surface activation, and wastewater decolorization; cathodic protection systems for pipelines, marine structures, and reinforced concrete; piezoelectric and ferroelectric material poling including PZT, BaTiO3, KNN, and PVDF systems; biomedical electrical stimulation including neuromuscular, transcranial, implantable stimulation, and electroporation devices; space and defense power systems including satellite battery management, RTG load management, betavoltaic conditioning, and pulse power applications; fusion energy research systems including capacitor banks and plasma-heating circuits; quantum computing and quantum device control systems including superconducting qubit control and ion trap electrode conditioning; electrokinetic and electrohydrodynamic systems including electroosmosis, electrowetting, dielectrophoresis, electrospray, and magnetohydrodynamic pump control; electro-optical and display systems including electrochromic devices, electroluminescent devices, and electrophoretic displays; and
any other electroactive process in which the temporal structure of the applied electrical excitation determines a physical, chemical, electrochemical, electromechanical, electro-optical, or quantum-physical outcome.

2. The system of claim 1, wherein in the single-source configuration, the power source (100) delivers the pre-engineered pattern directly to the electroactive device (130) through a filtering/shaping unit (120) controlled by the control engine (110).

3. The system of claim 1, wherein in a multi-source configuration, each power source delivers a separate pre-engineered pattern through respective isolation circuits and a merge/filter unit (180), the patterns being phase-shifted relative to one another by synchronization logic (270), and wherein the control engine (110) independently assigns functional roles to each power source including at least one of bulk energy delivery, high-frequency pattern stabilization, thermal management, or phase-offset conditioning.

4. The system of claim 1, wherein the pre-engineered pattern is selected from a pre-engineered pattern set comprising process-specific engineered temporal current structures whose geometric forms are determined by electrochemical analysis of the target system prior to operation, including structures with ramped, periodic, segmented, multi-phase composite, or other analytically derived geometries, and equivalents thereof.

5. The system of claim 1, wherein the parameter adjustment engine (190) computes updated scalar reference values for offset, amplitude, and duty cycle of the selected GPC pattern based on feedback data from the feedback interface (140), updates an internal current reference within the dynamic control unit (110) accordingly, and transmits control signals to the power source (100), wherein the power source (100) applies current and voltage to the electroactive device (130) by tracking said control signals, without having access to or knowledge of the fixed geometric structure of the selected pattern.

6. The system of claim 1, wherein the power source (100) comprises any current-and voltage-controllable power delivery device capable of receiving external control signals via analog output, digital communication protocol, or any other control interface, and wherein the dynamic control unit (110) interfaces with said power source (100) through said control interface without integration into or modification of the internal architecture of the power source (100), such that the system is universally deployable as a retrofit addition to any existing electrochemical power infrastructure.

7. The system of claim 1, wherein the system is configured for use in manufacturing and industrial production environments including gigafactory battery formation lines, electrochemical processing facilities, industrial electrolysis and hydrogen production plants, electroplating and electrodeposition production lines, electropolishing and electroforming facilities, anodizing and surface treatment facilities, semiconductor and electronic device fabrication environments including plasma-enhanced chemical vapor deposition conditioning, textile electrochemical processing facilities, and any other industrial setting in which electroactive processes are performed at production scale.

8. The system of claim 1, wherein the system is configured for deployment in field service, maintenance, and optimization environments including OEM battery service centers, in-field battery reconditioning and rebalancing setups, cathodic protection systems for buried pipelines, marine structures, and reinforced concrete infrastructure, electrochemical water and wastewater treatment plants serving municipal or industrial water supplies, and any other environment in which pre-engineered pattern control is applied to restore, maintain, or optimize the performance of an electroactive system already in service.

9. The system of claim 1, wherein the system is configured for high-power and rapid energy delivery applications including ultra-fast and mega charging stations for electric vehicles, grid-scale battery energy storage systems, industrial pulse power systems, defense directed-energy and radar power systems, and any other application requiring high-rate electrochemical energy delivery within defined thermal and electrochemical stress envelopes.

10. The system of claim 1, wherein the system is configured for integration within energy infrastructure, materials processing, research, and advanced technology environments including grid-connected battery energy storage systems, renewable energy storage coupled to solar or wind generation, hybrid energy hubs combining electrochemical storage and hydrogen production, electrochemical synthesis reactors, graphene and two-dimensional material processing systems, piezoelectric and ferroelectric poling systems, photovoltaic conditioning, fuel cell commissioning. biomedical electrical stimulation devices, space and defense power systems, quantum computing hardware, electrokinetic and electrohydrodynamic systems, and any other electroactive application domain disclosed in the specification.

11. The system of claim 1, wherein the pre-engineered pattern set comprises patterns generated through artificial intelligence or machine learning methods applied to electrochemical system data prior to operation, wherein said Al-generated patterns have a fixed geometric structure applied during operation without modification in response to operational feedback.

12. A method for controlling delivery of electrical energy from at least one power source (100) to at least one electroactive device (130), the method comprising:
selecting, by a pattern generation module (240), a pre-engineered, fixed-geometry current excitation pattern—referred to herein as Generated Pattern Current (GPC)—from a pre-engineered pattern set, wherein each pattern in the pre-engineered pattern set has been generated prior to operation through electrochemical engineering analysis of the target device chemistry or process, and has a fixed geometric structure designed independently of operational feedback;
applying the selected pattern to the electroactive device (130) during an operational phase;
monitoring, by a feedback interface (140), at least voltage, current, temperature, and impedance of the electroactive device (130) in real time;
dynamically adjusting one or more scalar delivery parameters of the selected pattern, including offset, amplitude, and duty cycle, based on the monitored data, without altering the fixed geometric structure of the selected pattern;
and optionally switching to another pre-engineered pattern from the pre-engineered pattern set if the monitored data indicates that such a change will improve process stability, reduce thermal stress, or optimize process completion, wherein said switching constitutes a transition between two independently engineered fixed-geometry patterns, and not a modification of the pattern geometry in response to feedback;
wherein the method is applicable to any electroactive system or process whose outcome depends on the temporal structure of electrical excitation, including but not limited to electrochemical energy storage systems including lithium-ion, solid-state, sodium-ion, lithium-sulfur, multivalent-ion, zinc-based, redox-flow, metal-air, and equivalent battery chemistries; electrochemical energy conversion devices including fuel cells and photovoltaic systems; electrochemical capacitors, supercapacitors, and hybrid capacitors; industrial electrochemical processes including water electrolysis, hydrogen production, electroplating, electrochemical dissolution, anodizing, electropolishing, electroforming, and electrochemical synthesis; electrochemical material processing including graphene and two-dimensional material exfoliation and deposition; semiconductor and electronic device conditioning including electrical annealing, dopant activation, memristive element programming, and plasma-enhanced chemical vapor deposition conditioning; electrochemical water and wastewater treatment including electrocoagulation, electrooxidation, electrochlorination, and electrodialysis; textile electrochemical processing including dyeing, bleaching, surface activation, and wastewater decolorization; cathodic protection systems for pipelines, marine structures, and reinforced concrete; piezoelectric and ferroelectric material poling including PZT, BaTiO3, KNN, and PVDF systems; biomedical electrical stimulation including neuromuscular, transcranial, implantable stimulation, and electroporation devices; space and defense power systems including satellite battery management, RTG load management, betavoltaic conditioning, and pulse power applications; fusion energy research systems including capacitor banks and plasma-heating circuits; quantum computing and quantum device control systems including superconducting qubit control and ion trap electrode conditioning; electrokinetic and electrohydrodynamic systems including electroosmosis, electrowetting, dielectrophoresis, electrospray, and magnetohydrodynamic pump control; electro-optical and display systems including electrochromic devices, electroluminescent devices, and electrophoretic displays; and
any other electroactive process in which the temporal structure of the applied electrical excitation determines a physical, chemical, electrochemical, electromechanical, electro-optical, or quantum-physical outcome.

13. The method of claim 12, wherein the process is performed in a single-source configuration, and the selected pre-engineered pattern is delivered directly from the power source (100) to the electroactive device (130) through a filtering/shaping unit (120).

14. The method of claim 12, wherein the process is performed in a multi-source configuration, each power source delivering a separate pre-engineered pattern through respective isolation circuits and a merge/filter unit (180), the patterns being phase-shifted relative to each other via synchronization logic (270), and wherein the dynamic control unit (110) independently assigns functional roles to each power source.

15. The method of claim 12, wherein the pre-engineered pattern is selected from a pre-engineered pattern set comprising process-specific engineered temporal current structures whose geometric forms are determined by electrochemical analysis of the target system prior to operation, including structures with ramped, periodic, segmented, multi-phase composite, or other analytically derived geometries, and equivalents thereof.

16. The method of claim 12, wherein the method further comprises computing updated scalar reference values for amplitude, offset, and duty cycle of the selected GPC pattern based on feedback data, updating an internal current reference within the dynamic control unit (110) accordingly, and transmitting control signals to the power source (100), wherein the power source (100) applies current and voltage to the electroactive device (130) by tracking said control signals, without having access to or knowledge of the fixed geometric structure of the selected pattern.

17. The method of claim 12, wherein the method is implemented using any current-and voltage-controllable power delivery device as the power source (100), the method further comprising transmitting control signals from the dynamic control unit (110) to the power source (100) via analog output, digital communication protocol, or any other control interface, without modifying the internal architecture of the power source (100), thereby enabling universal retrofit deployment across existing laboratory, industrial, and field power delivery infrastructure.

18. The method of claim 12, wherein the method is implemented in manufacturing and industrial production environments including gigafactory battery formation lines, electrochemical processing facilities, industrial electrolysis and hydrogen production plants, electroplating and electrodeposition production lines, electropolishing and electroforming facilities, anodizing and surface treatment facilities, semiconductor fabrication environments, textile electrochemical processing facilities, and any other industrial setting in which electroactive processes are performed at production scale.

19. The method of claim 12, wherein the method is implemented in field service, maintenance, and optimization environments including OEM battery service centers, in-field battery reconditioning setups, cathodic protection systems for pipelines, marine structures, and reinforced concrete, electrochemical water and wastewater treatment plants serving municipal or industrial water supplies, and any other environment in which pre-engineered pattern control is applied to restore, maintain, or optimize an electroactive system already in service.

20. The method of claim 12, wherein the method is implemented in high-power and rapid energy delivery applications including ultra-fast and mega charging stations for electric vehicles, grid-scale battery energy storage systems, industrial pulse power systems, defense directed-energy and radar power systems, and any other application requiring high-rate electrochemical energy delivery within defined thermal and electrochemical stress envelopes.

21. The method of claim 12, wherein the method is implemented in energy infrastructure, materials processing, research, and advanced technology environments including grid-connected battery energy storage, renewable energy storage, hybrid energy hubs, electrochemical synthesis reactors, graphene and two-dimensional material processing, piezoelectric and ferroelectric poling, photovoltaic conditioning, fuel cell commissioning, biomedical electrical stimulation, space and defense power systems, quantum computing hardware, electrokinetic and electrohydrodynamic systems, and any other electroactive application domain disclosed in the specification.

22. The method of claim 12, wherein the pre-engineered pattern is generated through artificial intelligence or machine learning methods applied to electrochemical system data prior to operation, wherein the generated pattern has a fixed geometric structure applied during operation without modification in response to operational feedback.

23. The system of claim 1, wherein the electroactive device (130) comprises any device or system whose electrochemical, electrophysical, or electromechanical behaviour is determined by or is responsive to the temporal structure of the applied electrical excitation, regardless of application domain, device geometry, electrolyte composition, electrode material, or operating environment, and wherein the pre-engineered pattern set comprises at least one pattern specifically engineered for the electrochemical or electrophysical characteristics of said device or system.
